(19) United States
(12) Patent Application Publication
(10) Pub. No.: US 2011/0026434 A1
(43) Pub. Date: Feb. 3, 2011

(54) LOCALIZATION OF LUMINAIRES

(75) Inventors: Petrus Desiderius Victor Van Der Stok, Helmond (NL); Manuel Eduardo Alarcon-Rivero, Delft (NL); Willem Franke Pasveer, Dordrecht (NL); Mihai Adrian Tiberiu Sanduleanu, Yorktown Heights, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/867,277

(22) PCT Filed: Feb. 13, 2009
(86) PCT No.: PCT/IB09/50604

§ 371 Date: Aug. 12, 2010

(30) Foreign Application Priority Data
Feb. 18, 2008 (EP) 08101719.6

(51) Int. Cl. H04L 12/28

(52) U.S. Cl. 370/254

(57) ABSTRACT

A node detection system includes an array of nodes (510), wherein each node of the array of nodes (510) has at least at least two, three or four directional antennas (530) configured to have antenna beams in as many directions. The range of each antenna is limited to reach a neighboring operational node of the array of nodes (510) for transmission of a message to the neighboring operational node. A controller (550) is configured to receive messages from the array of nodes (510) and determine the location of each node based on the messages.

The present invention relates to identifying location of luminaires or light fixtures for selective control thereof to provide a desired illumination in a space, such as a greenhouse, where light control is desired using a relatively large number of luminaires based on various factors, including external, e.g., natural, lighting conditions.

Typically, there are many luminaires in large spaces, such as halls, buildings or homes with multiple rooms. A lighting control system for individual control of each luminaire is desirable. Of course, the location and identity of luminaires are needed in order to control the desired luminaire to provide the desired illumination at the desired location. Manual commission of a lighting control system, such as manually providing information related to each luminaire, such as its identity and location, is a tedious and costly process.

For example, in greenhouses, a desire exists to improve the illumination by selectively switching on or off luminaires to adapt the quantity of artificial light to the needed quantity, e.g., as function of the external light conditions. For individual control of each luminaire, the luminaires are equipped with wireless nodes (one node per luminaire) to control the individual luminaires. The nodes form a wireless mesh network. Commands may be sent from any wireless control point to any node (and consequently any luminaire) in the network.

To send a command to a given luminaire, the identity of the luminaire must be known. In addition, for the user controlling the lamps or luminaire, the identity of the luminaire must be related to the location of the luminaire in the greenhouse so that a particular luminaire located at a particular location is addressed or controlled. Relating each luminaire to its location is a slow process due to the large quantity of luminaires in a greenhouse, or any other space with a large number of luminaires. Accordingly, there is a need for automatic commissioning of lighting control systems to automatically determine and associate the location of a luminaire to its identity.

One object of the present systems and methods is to overcome the disadvantages of conventional lighting control systems.

According to illustrative embodiments, a node detection system includes an array of nodes, wherein each node of the array of nodes has at least two directional antennas, such as two, three or four directional antennas configured to have antenna beams in as many directions, such as at least in two directions. The range of each antenna is limited to reach a neighboring operational node of the array of nodes for transmission of a message to the neighboring operational node. A controller is configured to receive messages from the array of nodes and determine the location of each node based on the messages.

Further areas of applicability of the present systems and methods will become apparent from the detailed description provided hereinafter. It should be understood that the detailed description and specific examples, while indicating exemplary embodiments of the systems and methods, are intended for purposes of illustration only and are not intended to limit the scope of the invention.

These and other features, aspects, and advantages of the apparatus, systems and methods of the present invention will become better understood from the following description, appended claims, and accompanying drawing where:

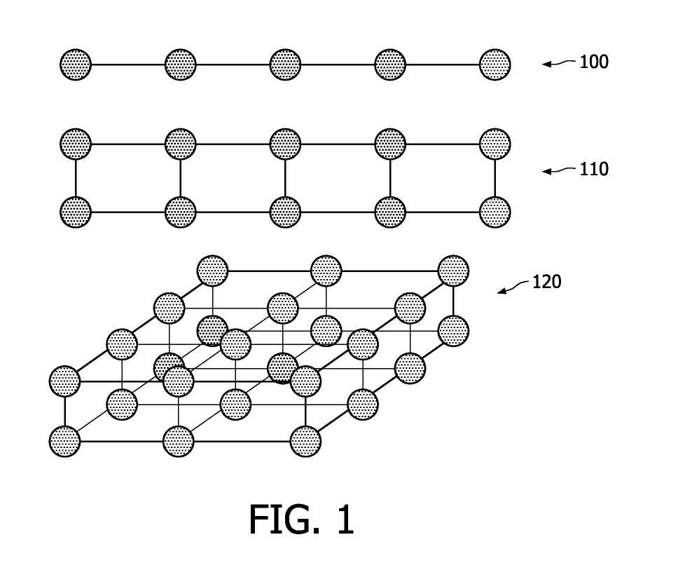

FIG. 1 shows various configurations of nodes of a network according to one embodiment;

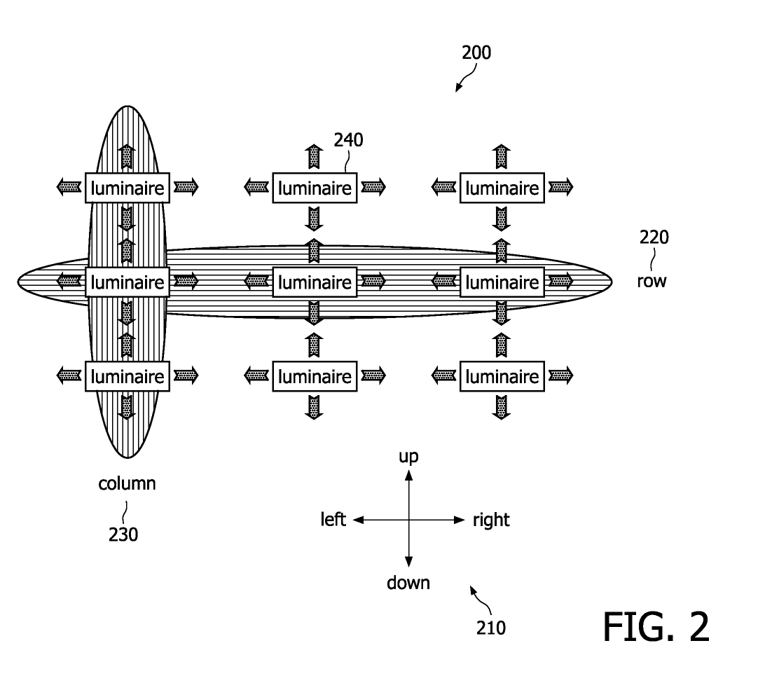

FIG. 2 shows a topology of a wireless mesh network according to one embodiment;

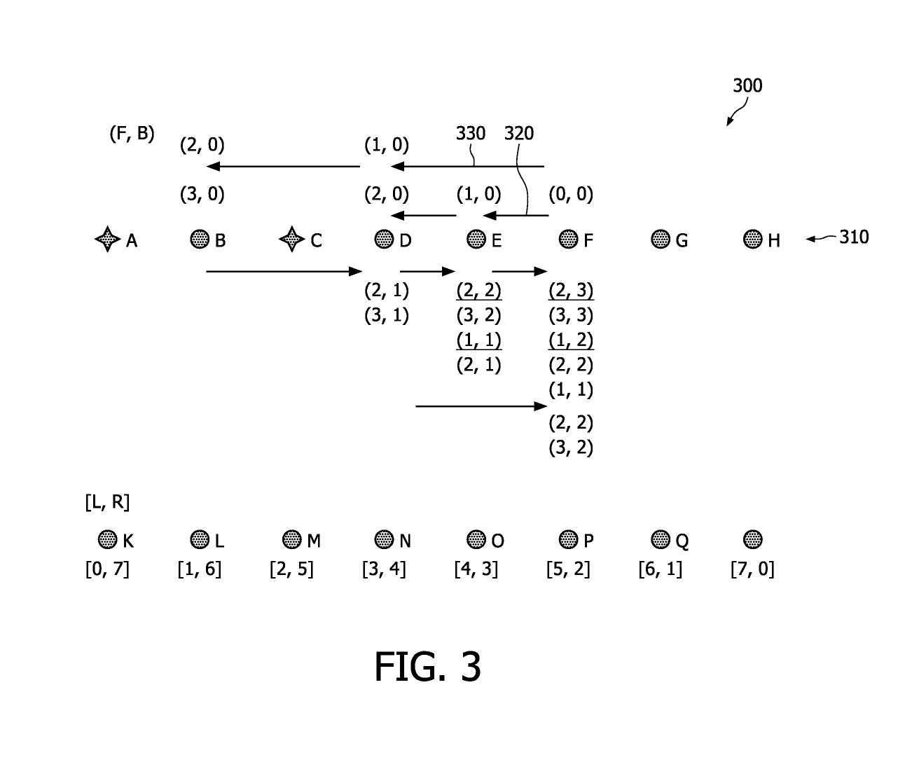

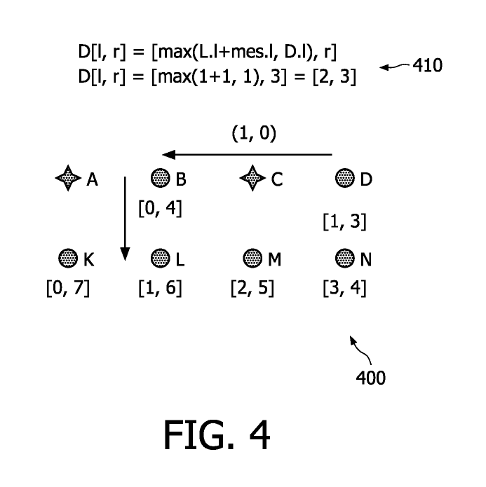

FIGS. 3-4 show node configurations and messages exchanged between nodes according to one embodiment;

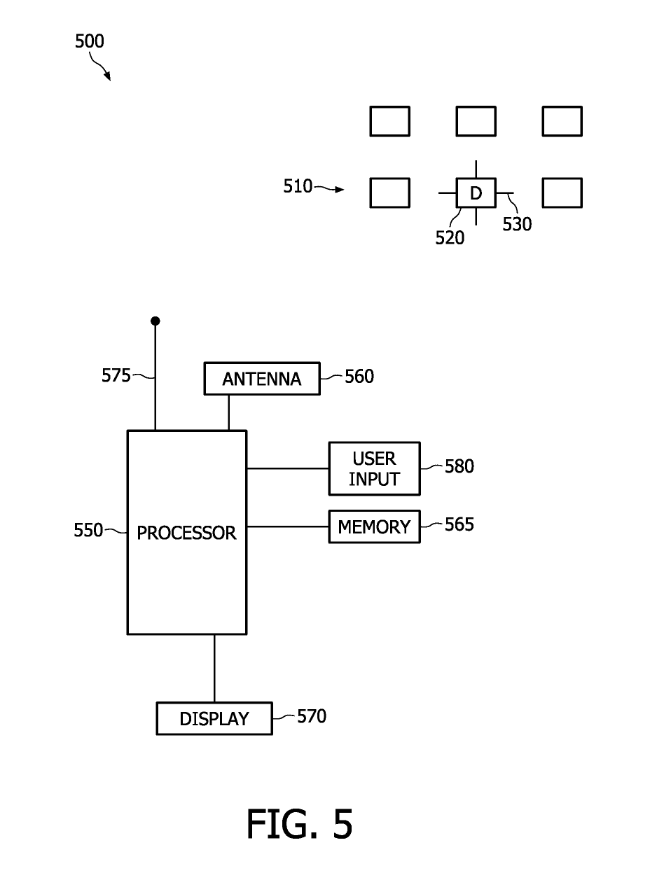

FIG. 5 shows an array of wireless node and a block diagram of a control system according to one embodiment;

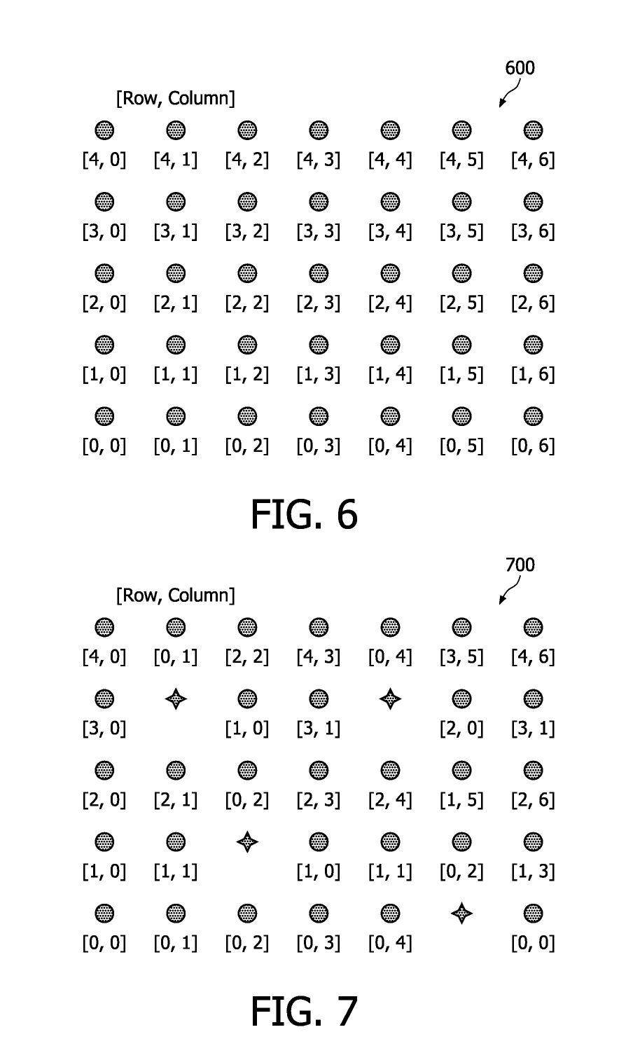

FIGS. 6-10 show results of wireless node location determination in an array according to further embodiments;

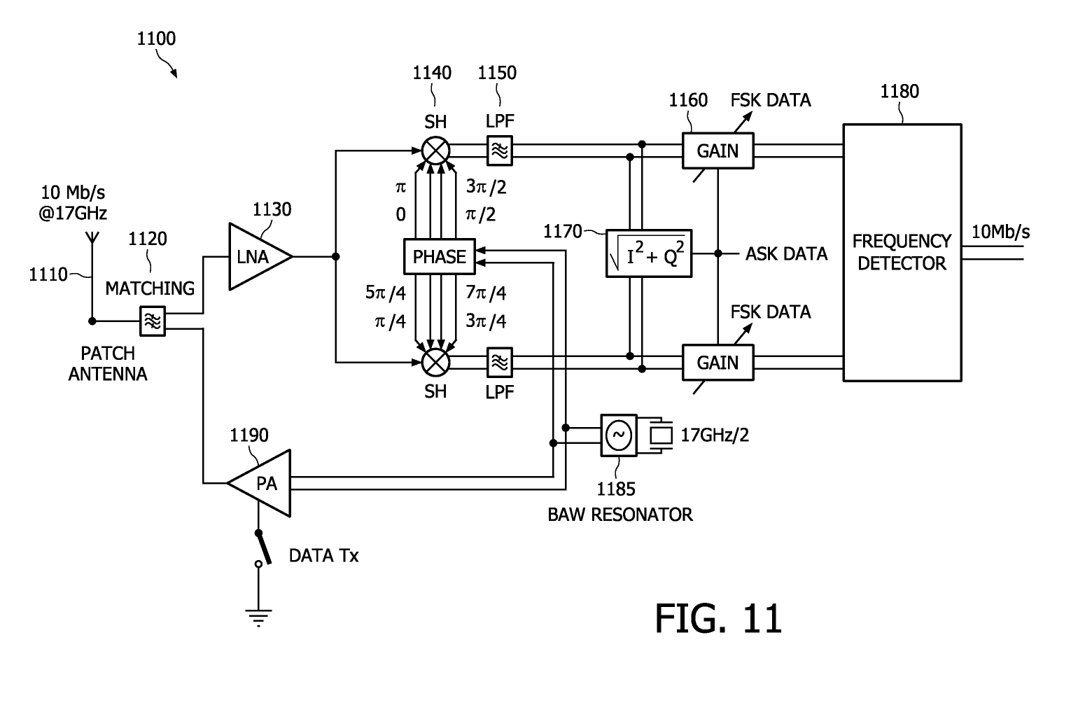

FIG. 11 shows an architecture of a 17 GHz ultra low-power transceiver according to one embodiment;

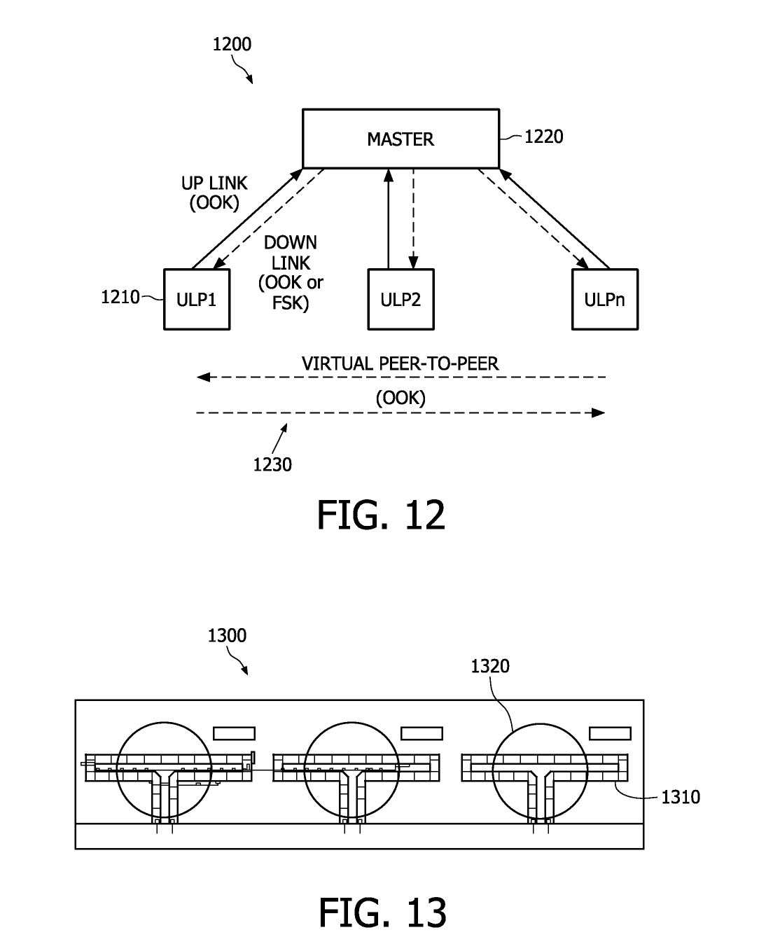

FIG. 12 shows a master-slave asymmetrical link system according to another embodiment;

FIG. 13 shows an antenna array for fair beam forming according to one embodiment;

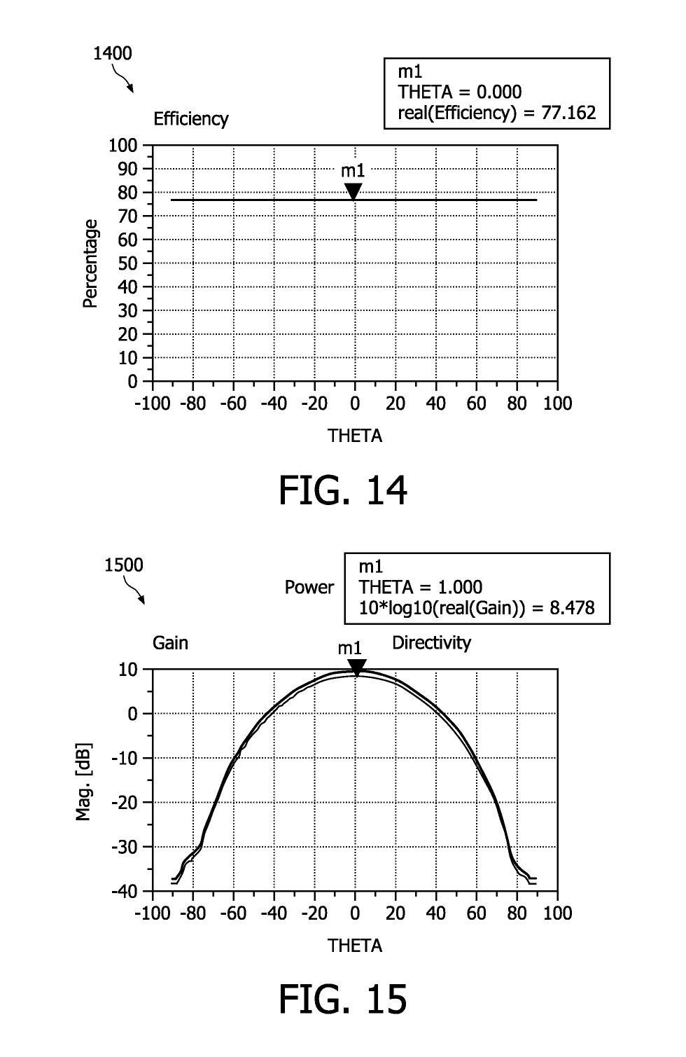

FIG. 14 shows the efficiency of the antenna array shown in FIG. 11 according to one embodiment;

FIG. 15 shows the gain of the antenna array shown in FIG. 11 according to one embodiment; and

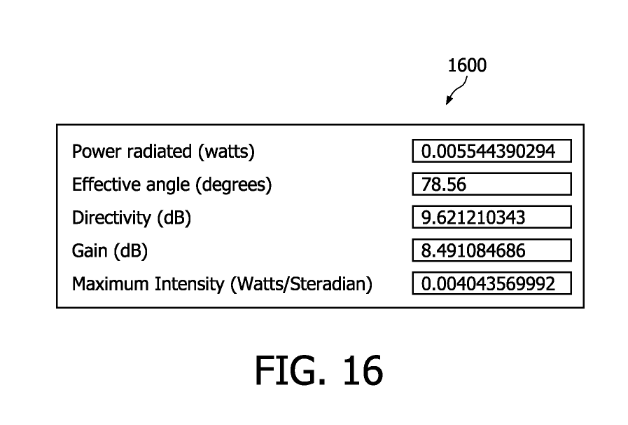

FIG. 16 shows data related to the antenna array shown in FIG. 11 according to a further embodiment.

The following description of certain exemplary embodiments is merely exemplary in nature and is in no way intended to limit the invention, its applications, or uses. In the following detailed description of embodiments of the present systems and methods, reference is made to the accompanying drawings which form a part hereof, and in which are shown by way of illustration specific embodiments in which the described systems and methods may be practiced. These embodiments are described in sufficient detail to enable those skilled in the art to practice the presently disclosed systems and methods, and it is to be understood that other embodiments may be utilized and that structural and logical changes may be made without departing from the spirit and scope of the present system.

For purposes of simplifying a description of the present system, the term “operatively coupled” and formatives thereof as utilized herein, such as “operationally coupled” and the like, refer to a connection between devices or portions thereof that enables operation in accordance with the present system. For example, an operative coupling may include one or more of a wired connection and/or a wireless connection between two or more devices that enables a one and/or two-way communication path between the devices or portions thereof.

The following detailed description is therefore not to be taken in a limiting sense, and the scope of the present system is defined only by the appended claims. The leading digit(s) of the reference numbers in the figures herein typically correspond to the figure number, with the exception that identical components which appear in multiple figures are identified by the same reference numbers. Moreover, for the purpose of clarity, detailed descriptions of well-known devices, circuits, and methods are omitted so as not to obscure the description of the present system.

Luminaires are provided that are part of a wireless network of nodes where different protocols and frequencies are used for wireless communication among a central controller and the various nodes. The IEEE 802.15.4 low power Wireless Personal Area Network (WPAN) standard is one of the most popular standards for communication within Wireless Sensor Networks (WSN). Another popular standard or protocol for wireless communication is the ZigBee™ standard which is based on the IEEE 802.15.4 standard. Wireless communication may be degraded for many reasons.

Experience, theoretical analysis and simulation show that the success probability of sending a packet strongly depends on the environment. One source of interference is referred to as multipath interference, where a radio wave from a source travels to a detector via two or more paths having different lengths, thus arriving with different delays or phases. The out-of-phase multipath signals arriving at a detector may degrade reception quality and cause loss of data. Multipath interference changes in time and leads to reception quality fluctuations ranging from 100% success to no reception at all.

Other simulations for IEEE 802.15.4 nodes show that communication becomes difficult with more than 40 nodes. Further, beyond 100 nodes, packets no longer arrive at the intended destination, e.g., a detector or a receiver, or are no longer successfully received by the detector or receiver. In view of such reception degradation, the deployment of IEEE 802.15.4 needs additional measures to make it work in a wireless network or an environment with large number of nodes or luminaires (where at least one luminaire is connected to one node). One such network or environment is a greenhouse with 10,000 to 40,000 luminaires (and nodes) within one greenhouse of 100 meters by 400 meters, for example.

In one embodiment, directional antennas are used to limit the number of transmission paths. Further, limited range communication is used to limit the number of paths and the probability of interference between senders or transmitters. For example, directional antenna gains and transmission power of each node are configured for reaching a one-hop neighboring node.

In the case where a one-hop neighboring node is missing or non-operational, then a central processor or controller (550 in FIG. 5) may be configured to increase the transmission power of a node having a non-operational or missing neighboring node, so that transmission from this node reaches an operational neighboring node which is two or N hops away (through or counting the non-operational or missing neighboring node as a hop). Illustratively, the controller 550 may also be configured to detect a missing or non-operational node by examining the mapping of the nodes to their respective locations in the network array where, for example, column and row numbers of each node is determined, and by analyzing inconsistencies in the results of the mapping from expected results.

Higher frequencies are used for communication between nodes since higher frequencies provide for smaller antennas and lower range. For example, communication in a frequency range at or around the 17 GHz frequency domain will enormously increase the probability of successful transmission between neighboring nodes. The directed or directional antenna for 17 GHz is a few Milli-Meters (mm), where for 2.4 GHz it is several Centi-Meters (cm). The smaller antenna leads to less sensitivity to mechanical damage. Further, the range of the 17 GHz is reduced, such as limited to a few meters, which means that only 1 hop or at most two hop neighbors (or nodes) may be reached in a greenhouse, thus significantly reducing the multi sender interference. Thanks to the limited range and limited angular coverage in the 17 GHz range, automatic topology discovery of the luminaires becomes less of a technology challenge, than would be the case with the 2.4 GHz IEEE 802.15.4 radio protocol.

By limiting the range of each antenna to a desired distance, such as enough distance to reach only one neighboring working node in an array or grid of nodes, e.g., one or two hops from one node to the neighboring node, the wireless array mimics or behaves like a wired array where neighboring nodes are connected by wires. In case a neighboring node is missing or faulty, which may be detected from mapping results that are not expected, then the controller 550 may be configured to increase the range, e.g., by increasing the power of nodes surrounding the missing or faulty node to achieve two hops in order to reach a neighboring working node. Of course, the range may be increased to any desired number of hops, such as three hops in case there are two missing or faulty nodes. It should be understood that although the present systems, devices and methods, are described in a greenhouse environment, any other environment with multiple nodes is also suitable where typically multipath interference degrades communication, for example.

Typically, a luminaire has a housing, which may be rectangular, for example, and includes a local controller or a ballast, for example. According to one embodiment, a directional antenna may be attached to at least four sides of the housing or ballast, such as to each of the four sides of the housing or ballast. The effect is that each antenna emits its radio signal perpendicular to the side of the ballast in a horizontal direction. Of course, any shape luminaires may be used, and at least four directional antennas may be provided on each luminaire in orthogonal position, such as front, back, (or up, down,) right and left, as shown by the coordinate system 210 in FIG. 2. The four antennas need not be orthogonal to each other, so long as a first antenna of a first device point towards a second antenna of a second device to allow communication between the first and second devices. Other antennas may be perpendicular to the first and/or second antenna.

A node may have neighbors in two directions, forming a line of nodes 100, as shown in FIG. 1. Additionally or alternately, a node may have neighbors in three directions, such as two interconnected lines 100 forming a rail road track 110. Further, a node may have neighbors in six directions, forming interconnected grids 120, where such a node(s) may have six directional antennas for communicating with its six neighboring nodes.

FIG. 2 shows the topology of a wireless mesh network 200, according to one embodiment. As shown in FIG. 2, the network comprises luminaires 240 arranged in array of rows 220 and columns 230. Each luminaire 240 determines its location within the mesh network 200 and communicates this information to a central control computer or processor (550 in FIG. 5). The location is expressed in column and row numbers. The central control computer or processor 550 receives the locations of the individual nodes and distributes this information to the associated control points. For ease of understanding, the following description is divided into a description of a topology algorithm executable by the processor 550 shown in FIG. 5, a communication section or radio part related to radio links, transceivers and modulation schemes, and an antenna part.

### Topology Algorithm

The algorithm (e.g. instructions executable by the processor 550) may be divided in two phases. First, for a row 220, the relative location of each luminaire or wireless node 240 along the row 220 is determined. The problem is the absence of nodes, and the possibility that a message arrives not only at the one hop neighbor, but also arrives at the neighbor which is two or more hops away. The assumption is that the arrival of a message at the n-hop neighbor implies that the message arrives also at the n−1 hop neighbor, provided both (the n and the n−1 neighbor) exist. This is depicted in FIG. 3, which shows a node configuration 200 and messages exchanged between nodes.

FIG. 3 shows a first phase of the procedure or algorithm where evaluation is performed on a row basis. That is, for each row, the location of each node given in terms of Left [L] and right [R] values are determined. At the end of the first phase, each node has an associated location [L,R] determined from right forward (F) and backward (B) counters, and from left forward (F) and backward (B) counters.

In FIG. 3, the first row 310 has labeled nodes A-H, where nodes A and C (shown as stars) are missing. One hop and two hop messages are shown as short arrows 320 and long arrows 330, respectively. Two or more hop messages occur between neighboring active nodes, where nodes between the two neighboring active nodes are either missing or inactive. To determine the relative location of a node, the node transmits a message or signal that includes its own identifier over its left and right antenna with the direction (right or left), as well as a forward counter and a backward counter both set to 0, denoted as (F,B)=(0,0) above node F in FIG. 3. A node receives messages and acts as function of the message content.

Suppose the identifier in the message is unequal to the identifier of the receiving node. On reception of a message on the right (left) antenna with (F, B), then the receiving node performs the following operations:

(1) increments the forward counter F and sends the message to its left (right) antenna, and

(2) increments the backward counter B and sends the message over its right (left) antenna.

Suppose the identifier in the message is equal to the identifier of the receiving node. On reception, the receiving node stores the message when the B and F value are equal. B and F being equal indicates that the forward and backward hops are equal which is correct and acceptable, resulting in storage if the node identification in the message is the same identification (ID) as the receiving node. If B and F values are not equal, then there is missing hop or node, and the message is rejected and not stored despite the message ID being the same as the receiving node ID. When a message is already stored in a receiving node, then the receiving node keeps the message with the highest B, F value, where B=F and the message ID is the same as the ID of the receiving node.

Accordingly, in FIG. 3, when the message having a node ID of “F” and a message value of (F,B)=(3,3) is received by node “F” from the left side, then the left location value “L”=3 for node “F” is stored in node “F”. The same procedure is repeated in the right direction and upon receipt, from the right side at node “F,” of a message having a node ID of “F” and a value where the forward and backward counters are equal F=B, namely F=B=2, then the right location value “R” for node “F” is stored in node “F” as 2 (i.e., R=2), resulting in a location value [L,R] for node “F” being [3,2]. This indicates that there are 3 nodes to the left of node “F”, namely, nodes B, D and E, and that there are 2 nodes to the right of node “F”, namely, node G and H.

The result of phase one for determination of the left location value [L] for node “F” in one row at a time is worked out in FIG. 3 for the node identified as “F”. It is assumed that node B is reachable from node D, and node D is reachable from both nodes F and E. The contents of the forward messages are shown above the arrows, and contents of the returned messages are shown below the messages. The relative location of node F with respect to the nodes to its left is given by the contents of message (3,3). These (F, B) values for node F of (3, 3) for the left direction indicate that there are 3 nodes to the left of node F, namely nodes E, D and B, and thus the value of the left location L for node F is 3 [L=3]. Of course, this may not be related to the correct location of F in the grid due to the missing nodes at location A and C. The same algorithm is applied for the right hand side.

The final result of phase one for determination of left and right location values [L,R] for nodes in one row, determined one row at a time, is shown in the lower part of FIG. 3 for nodes K through R where no nodes are missing. As shown, each node maintains its location expressed as left location [L] and right location [R] denoted as [L, R] in the lower part of FIG. 3 where no nodes are missing. For example, [L, R] values for node K are [0, 7], indicating that there are zero (L=0) nodes to the left of node K, and there are seven (R=7) nodes to the right of node K, namely, nodes L, M, N, 0, P, Q and R.

The procedure or algorithm may be optimized by not sending (B, F) messages with B≧F, such as the underlined messages shown in FIG. 3.

Once the left and right locations [L, R] of each node in one row (or column) is determined, then the second phase of the algorithm determines the row (or column) number for each node and corrects for missing nodes.

The location of each node [L, R] is expressed as hop count from the left most and right most node. The hop count is always smaller or equal than the column count. By sending the [L, R] coordinates down the rows over a column, they can be compared with the [L, R] coordinates of the lower nodes (in the lower rows). By taking the maximum of both [L, R] values of the node in the current row and the node in the lower row, the location coordinates [L, R] may be found for each node. It should be understood that columns and rows may be used interchangeably and merely designate two directions in a grid or matrix and may be orthogonal to each other.

For example, assume that node B has coordinates [0,4]. As shown in the array 400 of FIG. 4, the coordinates [0,4] of node B are sent to the corresponding (i.e., in the same column and) lower node in the lower row, namely node L having coordinates [1,6], as also shown in FIG. 3. The coordinates or hop counts of nodes in the same column but adjacent rows (e.g., nodes B and L) are compared and the maximum chosen. That is, the hop count [0,4] of node B is changed to [1,6] by taking the maximum of the two L-values of the two (upper and lower) nodes B and L (namely 0 and 1), and the maximum of the two R-values for nodes B and L (namely 4 and 6). It should be noted that a message includes a row hop counter which is incremented each time the message is sent down a row. Thus, for example, if the array of nodes includes only the two rows shown in FIG. 4, then the processor 550 collects messages from the lowest nodes, which include the location of node B corrected from [0,4] to [1,6] in row two or the upper row (since the row hop counter for node B is incremented when the message is sent from node B to node L in the lower or first row). Another message collected by the processor 550 relates to the location of node L, where this message is [1,6] but in row one or the lower row, as its row_counter has not changed indicating L is in the lowest row.

Suppose the lower node in the same column does not exist (e.g., N does not exist), then the message (e.g., [1,3]) is first sent to the right or to the left and then sent down to a node that exists in the lower row. However the hop count right or left is not necessarily equal to the location count. Consequently, for messages to the right only, the right count may be adapted or changed, while the adaptation for the left count is undetermined. This is shown in FIG. 4, where node D first sends its location [L,R]=1,3 one hop to the left (i.e., left hop count=1 shown as (F,B)=(1,0) above the arrow from node D to node B in FIG. 4) and then one hop down. The left value of D is then selected to be at least the left hop count value of L, namely 1, plus the left hop displacement of the message (1, 0) from node D to node B which is also equal to 1 (i.e., one hop from node D to node B). Thus, the new left value L for node D is the maximum of the old left value L=1 (since node D had values [L,R]=[1,3]) and L+left hop count/displacement=1+1=2; i.e., Max (1, 2)=2, resulting in a change in left/right location values [L,R] of node D from [1,3] to [2,3]. Accordingly, D[2,3] is then substituted for the original D[1,3] as shown by reference numeral 410. This is an improvement to the original location but still not the correct one. When a row with missing nodes is a neighbor to a row with all correct or no missing nodes, then the algorithm will find the correct locations.

The algorithm works as follows. A node sends a message with its location in a row [L, R] and identifier (e.g., “D” for node D), forward hop count (or left value (L) in this illustrative example) and backward hop count (or right value (R) in this illustrative example) (F, B) and row hop count RC. The latter three, namely, forward hop, backward hop and row hop counts F, B, RC are initialized to 0. A node sends this message to the left, right and down and increases the corresponding hop counter. In particular, when the message is sent to the left or forward, then the left or forward hop counter or count F is increased by one; when the message is sent to the right or backwards then the right or backward hop count B is increased by one; and when the message is sent to the lower row, then the row hop count RC is increased by one.

On reception of a message by a node having the same identity or identifier as the identifier of the message, then the message is stored. When a message is already present, then the [L, R] location is updated as explained by keeping the maximum values, and the maximum of the row hop count is also stored. When the message is new or the content of the message is adapted, then the message is sent on with the latest values according to the following rules. For a message arriving from the row above the current row, then the message is sent over the left, the right and down, with corresponding hop counters incremented by one. For a message arriving from the right (left), the message is sent on to the left (right), and down with corresponding hop counters adapted, such as increasing the left counter F by one when the message is sent to the left with one hop, and increasing the row hop counter RC by one when the message is sent down to the row below.

At the lowest or most down nodes (i.e., the last row at the bottom), the messages are collected and sent on to the processor (550 in FIG. 5) or central control computer, which may also be a personal computer (PC), personal digital assistant (PDA), or any other device with a controller or processor, such as cell phone, remote controller etc. The processor 550 calculates the locations of the nodes having node identifiers and the location of the defective or missing nodes, where such information may be rendered on any rendering device, such as a display (570 in FIG. 5) where a mapping of the array or grid of nodes may be displayed with relevant information, such as node identifiers, location identifiers and indication of missing or defective nodes. Thus, a map identifying the nodes and their respective locations is formed by the processor 550 and provided to the user, e.g., rendered on a display. Of course, one or more selected nodes and their location(s) may be rendered, as desired. The algorithm is quite robust and allows the removal and insertion of new nodes during operation, where such node removals and insertions are detected and, in response to such node removal/insertion detection, the node array will be recalculated or updated for display on the screen 570, for example.

All messages with left hop, right hop, identifier, L value and R value and row count are sent on to the lowest row and, from there, sent on to the controller or processor 550 which may be PC, PDA or any device having a controller or processor. Within the PDA or PC, an entry is created for each identifier that arrives in a message. The entry contains the L value, R value, and an end hop count. For all messages of each identifier, the largest L, R and row numbers are stored.

Ordering the entries in two dimensions, over the row number and over the L value (or R value), for example, a map of node identifier to location is obtained. The L value (or R value) represents the column number, and the row_counter the row number. From this table it is possible to send a message from the PDA/PC to a given node, identified with column and row, by using the corresponding identifier using standard routing techniques. Scanning each row for the presence of all L-values, a missing L-value indicates a missing node.

Storing the messages according to identifier in each node is done for efficiency purposes. When a message with a given identifier arrives, and the same identifier with the same values is stored in the node, the receiving node does not need to send on the message. Consequently, the number of identical messages is significantly reduced at the expense of memory space in the node.

FIG. 5 shows system block diagram 500 with an array 510 of nodes where one illustrative node D is shown as a square 520 having four directional antennas 530, namely, one antenna 530 at each side. Of course, the nodes may be any shape so long as a node has a plurality of directional antennas pointed towards a plurality of directions, such as four directional antennas pointed towards four directions which may be orthogonal to each other. Further, the four directions may be substantially in one plane. Of course, any number of directional antennas and directions greater than two may be used, namely, as least two directional antennas pointed in as least two directions. Further, the various nodes of the array 510 may have the same or different number of directional antennas.

FIG. 5 also shows a central controller such as a processor 550 having an antenna 560 for communicating with at least one node in the array of nodes 510 and other devices. Of course, similar to the central controller 550, each node may also have its own processor or other devices, such as counters, memory and for processing and storing data such as identifiers and counts and executing various operational acts according the algorithms and comments stored in its memory or other memories and/or received through the antennas, for example. In one embodiment, a processor in each node of the array 510 may be configured to determine this node's location based on received messages and to store the determined location in the node's own memory. Thus, a PDA, PC, or the central processor 550 is not needed for forming any mapping of node identities to node locations.

In embodiments having the central controller 550, other devices may also be provided, such as a central memory 565, display 570, input/output devices and any other desired device. The central controller 550 may be operationally coupled to the central memory 565, the display 570, a wired connection 575 such as for access to the Internet or other networks, or connection to other devices, and a user input device 580. The memory 565 may be any type of device for storing application data as well as other data related to the described operations. The application data and other data are received by the processor 550 for configuring the processor 550 to perform operation acts in accordance with the present system. The operation acts may include powering on, searching for nodes, scanning, etc. Details of the system 500 are not introduced to simplify the discussion herein although would be apparent to a person of ordinary skill in the art. The system 500, depending on exactly the application, may include the user input or interface 580 and the display 570 to facilitate particular aspects of those embodiments although are not required for operation. For example, a user may provide user inputs via the user interface 580 to turn on/off or activate/deactivate various component of the system 500, turn on nodes and make adjustments as desired. The display 570 may be configured to display various data, such as a mapping of the nodes indicating node identities and respective locations, as well as showing missing or defective nodes, and any other desired information.

The operational acts of the processor 550 may further include controlling the display 570 to display any other content such as any content that would be applicable to the system 500, such as a user interface for control through a touch sensitive display, for example. The user input device 580 may be hardware or soft devices displayed on the touch sensitive display and may include a keyboard, mouse, trackball or other device. The display 570 and/or user input device 580 may be stand alone or be a part of a system, such as part of a personal computer, personal digital assistant, mobile phone, set top box, television or other device for communicating with the processor 550 via any operable link. The user input device 580 may be operable for interacting with the processor 550 including enabling interaction within the user interface and/or other elements of the present system. Clearly the processor 550, the memory 565, display 570, antenna 560 and/or user input device 580 may all or partly be a portion of an antenna device or other device for operation in accordance with the present system.

The methods of the present system are particularly suited to be carried out by a computer software program, such program containing modules corresponding to one or more of the individual steps or acts described and/or envisioned by the present system. Such program may of course be embodied in a computer-readable medium, such as an integrated chip, a peripheral device or memory, such as the memory 565 or other memory coupled to the processor 550.

The memory 565 and other memories configure the processor 550 to implement the methods, operational acts, and functions disclosed herein. The memories may be distributed, for example between the various nodes and the processor 550, where additional processors may be provided, may also be distributed or may be singular. The memories may be implemented as electrical, magnetic or optical memory, or any combination of these or other types of storage devices. Moreover, the term “memory” should be construed broadly enough to encompass any information able to be read from or written to an address in an addressable space accessible by the processor 550. With this definition, information accessible through the wired connection 575 (e.g., wired connection to a network such as the Internet), and/or through a wireless connection via the antenna 560, for example, is still within the memory 560, for instance, because the processor 550 may retrieve the information from one or more of the operable connections 560, 575 in accordance with the present system.

The processor 550 is operable for providing control signals and/or performing operations in response to input signals from the user input device 580 as well as in response to other devices of a network and executing instructions stored in the memory 565. The processor 550 may be an application-specific or general-use integrated circuit(s). Further, the processor 550 may be a dedicated processor for performing in accordance with the present system or may be a general-purpose processor wherein only one of many functions operates for performing in accordance with the present system. The processor 550 may operate utilizing a program portion, multiple program segments, or may be a hardware device utilizing a dedicated or multi-purpose integrated circuit. Further variations of the present system would readily occur to a person of ordinary skill in the art and are encompassed by the following claims.

Of course, it is to be appreciated that any one of the above embodiments or processes may be combined with one or more other embodiments and/or processes or be separated and/or performed amongst separate devices or device portions in accordance with the present system.

A second approach is further described below for commissioning algorithms that serve to allocate a position expressed in column and row to each node. In the second approach, various algorithms to determine node locations (e.g., row and/or column counts) are used, where each node stores its location in its node memory. The node locations are updated and the maximum counts between stored and received (row and/or columns) counts are stored in the node memory indicating the node location. Thus, the node location of a node, determined by the node itself, is stored in the memory of that node and there is no need for the central processor 550 to produce a mapping of node identities to node locations. Further, there is no need to store the node identities and locations, or any such mapping, in the central memory 565 shown in FIG. 5. Rather, each node determines and stores its location in its own node memory. Of course, the central processor may be configured to execute the instructions related to the various algorithms, or such instructions may be executed locally by processors located in the nodes which may, additionally or alternately, include counters, comparators and other elements for performing the various operations for determining the location of the node(s).

The complexity of the algorithm depends on the fault hypothesis and the range of the radio. The radio knows four directions up, down, left and right. The range of the radio is expressed in the number of hops. An x-neighbor is a neighbor in the x-direction, with x in {up, down, left, right}. One hops means: message reaches direct neighbor. Two hops means: message reaches neighbor and the neighbor's neighbor. Isolated faulty node means that the node is faulty but all its neighbors are correct.

Various scenarios are described where range is one or two hops, with no faulty node or isolated faulty nodes and with or without message losses. The number of hops may be detected from the strength of received signal, for example, where a signal received with lower power indicates that the signal traveled more than one hop, such as being a two-hop signal. Further, a range identifier may be included in the message by the receiver to indicate that the signal is received with 2-hops. It is assumed that all nodes are switched on before the algorithm is executed.

### Range is One Hop, No Faulty Nodes, No Message Loss

This case is the simplest one. Each node has a pair [column_counter, row_counter], which are initialized to (0, 0).

### Algorithm 1

Each node sends a message with the entry row_hops, initialized to 0, in the right direction. On reception of a message, ms, from the left direction, the value of ms.row_hops is incremented with one and the value of row_counter is set equal to MAX(ms.row_hops, row_counter). The message with the incremented value is sent on in the right direction.

The same process is repeated to calculate the column_counter value. Each node sends a message with the entry column_hops, initialized to 0, in the up direction. On reception of a message, ms, from the low direction, the value of ms.column_hops is incremented with one and the value of column_counter is set equal to MAX(ms.column_hops, column_counter). The end result is shown in the array 600 of FIG. 6. Circles represent nodes and the [x,y] pair represent the calculated row, and column numbers.

### Range is Two Hops, No Faulty Nodes, No Message Loss

In this case, algorithm 1 will execute equally well. Suppose a packet is received at the neighbor and the two hop neighbor. The message from the neighbor with the incremented hop count will reach the two hop neighbor as well. As the two hop neighbor will take the maximum of the received values the end result is the same as shown in FIG. 6.

### Range is One Hop, Isolated Faulty Nodes, No Message Loss

This case is more difficult. Suppose we execute the column- and the row-part of the algorithm, then the message will start and stop not only at the end points but also at the faulty nodes. In the array 700 shown in FIG. 7 the result on labeling shows that from the faulty node onwards, the row numbering and column numbering starts from zero again. A faulty node is represented with a star. It is assumes that faulty nodes are isolated, (i.e. they have no faulty one-hop neighbors). Under this assumption the algorithm can be made to work with more messages.

### Algorithm 2

Each node sends a message with the entry row_hops, initialized to 0, in the right direction. On reception of a message, ms, from the left direction and ms.row_hops<row_counter, the message is rejected. If ms.row_hops≧row_counter the value of ms.row_hops is incremented with one and the value of row_counter is set equal to MAX(ms.row_hops, row_counter). The message with the incremented value is sent on in the right, up and down direction. On reception of a message, ms, from the up (down) direction, the value of ms.row_hops is compared with the value of row_counter. When ms.row_hops>row_counter, row_counter is set equal to ms.row_hops, and the message is sent on in the right direction.

The same process is repeated to find the column_counter value. Each node sends a message with the entry column_hops, initialized to 0, in the up direction. On reception of a message, ms, from the down direction and ms.column_hops<column_counter, the message is rejected. If ms.column_hops≧column_counter the value of ms.column_hops is incremented with one and the value of column_counter is set equal to MAX(ms.column_hops, column_counter). The message with the incremented value is sent on in the up, left and right direction. On reception of a message, ms, from the left (right) direction, the value of ms.column_hops is compared with the value of column_counter. When ms.column_hops>column_counter, column counter is set equal to ms.column_hops, and the message is sent on in the up direction.

It can be seen from FIG. 7 that the algorithm works in most cases. For example the node [2, 2] was erroneously labeled with [0, 2] by the former algorithm. In this improved algorithm, the message arriving in [2, 3] from below will send the column value 2 to the left and the right and thus to [2,2]. The node 2, 2 will overwrite the 0 with the 2 and is correctly labeled. The node sends this message on up, where the node [2, 3], previously falsely labeled [1, 0] will change the labeling to [1, 3], and so forth. In the next stage also, the row number will be corrected. When the hop value in a message is lower than the calculated values in the node, the message is rejected, to reduce traffic and delay.

### Range is Two Hops, Isolated Faulty Node, No Message Loss

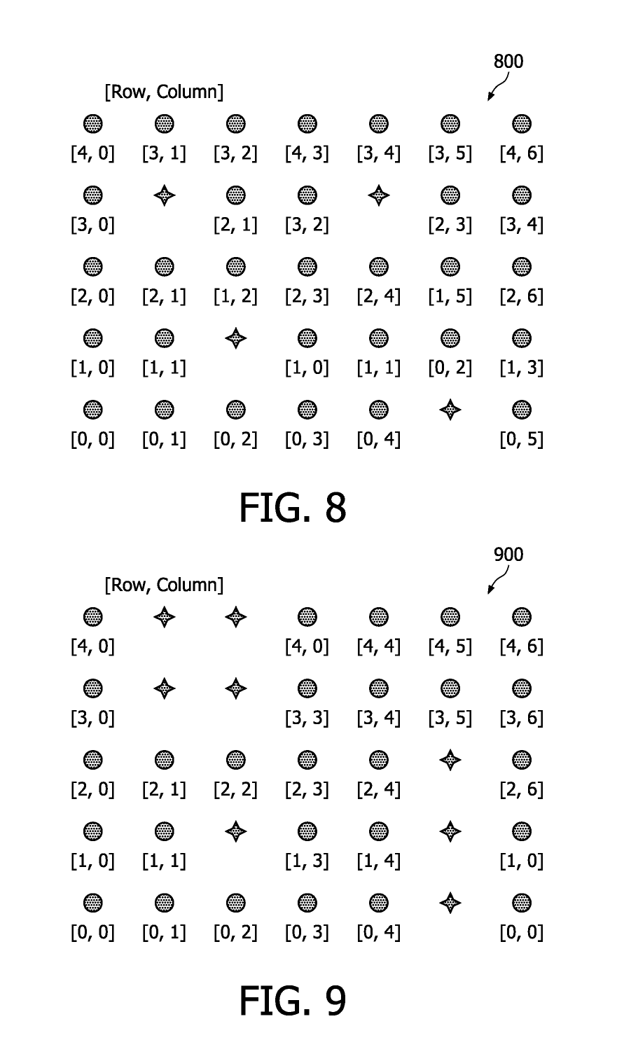

In this case the problem persists and the execution of algorithm 1 would have resulted in the labeling 800 shown in FIG. 8. The labeling after the faulty node does not start with 0 as in the case shown in FIG. 7 but continues with the value of the faulty node. The same algorithm may be applied as for the case of Algorithm 2, because the maximum values are taken over. And the one hop messages always pass overwriting the two-hop messages.

### Range is One Hop, Faulty Nodes, No Message Loss

FIG. 9 shows the unwanted result 900 of Algorithm 2 when several nodes on a row are faulty. For example the node [4, 3] is wrongly labeled with [4, 0], because the message with the column number 3 arrives at node [3, 3] via node [2, 3] but is not passed on to node [4, 3]. Column number of node [4, 4] is updated from node [3, 4]. The same happens for nodes [0, 6] and [1, 6] which are not updated from node [2, 6]. The algorithm can be made more robust by sending more messages in a row or column direction. In the third algorithm below, the extensions to algorithm 2 are underlined.

### Algorithm 3

Each node sends a message with the entry row_hops, initialized to 0, in the right direction. On reception of a message, ms, from the left direction and ms.row_hops<row_counter, the message is rejected. If ms.row_hops>row_counter the value of ms.row_hops is incremented with one and the value of row_counter is set equal to MAX(ms.row_hops, row_counter). The message with the incremented value is sent on in the right, up and down direction. On reception of a message, ms, from the up (down) direction, the value of ms.row_hops is compared with the value of row_counter. When ms.row_hops≧row_counter, row_counter is set equal to ms.row_hops, and the message is sent on in the right, up and down direction.

The same process is repeated to find the column_counter value. Each node sends a message with the entry column_hops, initialized to 0, in the up direction. On reception of a message, ms, from the down direction and ms.column_hops<column_counter, the message is rejected. If ms.column_hops≧column_counter the value of ms.column_hops is incremented with one and the value of column_counter is set equal to MAX(ms.column_hops, column_counter). The message with the incremented value is sent on in the up, left and right direction. On reception of a message, ms, from the left (right) direction, the value of ms.column_hops is compared with the value of column_counter. When ms.column_hops>column_counter, column_counter is set equal to ms.column_hops, and the message is sent on in the up, right and left direction.

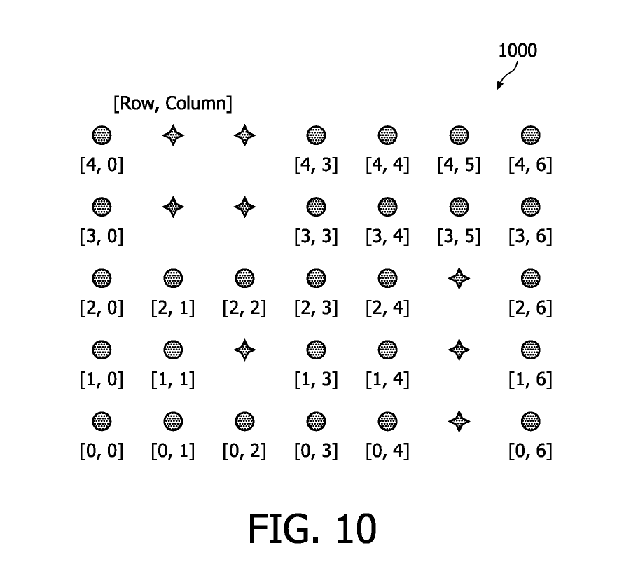

When neighboring faulty nodes are placed in a row or a column, the algorithm works perfectly (provided that there is no network separation), as shown in the results 1000 of algorithm 3 shown in FIG. 10. It should be noted that the algorithms described related to the second approach are configured to have each node determine and/or store its location in its own node memory. Thus, a PDA, PC, or the central processor 550 is not needed for forming a mapping of node identities to node locations. Further, there is no need to store the node identities/location or any such mapping in the central memory 565 shown in FIG. 5. Rather, each node stores its location in its own node memory.

### Communication Section

For the radio part, high frequencies are used in order to substantially limit the communication range of each node, such as to few meters for only 1 hop or two hops to its neighbors. If necessary, certain nodes or certain portions of the certain nodes may be configured for longer range communication, such as end nodes having portions configured for communication with the central controller 550 which may be at longer distance then a few meters. Of course, intermediary nodes may be provided to facilitate communication between the nodes of the array 510 and the central controller 550. Illustratively, a 17 GHz transceiver system is provided in each node of the array and other nodes, such as intermediary nodes and the central controller 550. The power consumption may be around 20 mW, where the data rate may be 10 Mbit/s, and the turn-on time of several μs. FIG. 11 shows a transceiver architecture 1100 which may be the slave part of an asymmetrical system employing a master device and ultra low-power nodes. Of course, other high frequencies may also be used such as 24 GHz.

As shown in FIG. 11, an RF signal at 17 GHz is received by an antenna 1110 which may be a patch antenna and provided through a matching network 1120 to a Low Noise Amplifier (LNA) 1130. The output of the LNA 1130 is connected to a sub-harmonic mixer 1140 whose outputs are filtered by Low Pass Filters (LPFs) 1150 and provided through gain controllers 1160 and a square root detector 1170 to a frequency detector 1180. A local oscillator (LO) 1185, such as a Bulk Acoustic Wave (BAW) resonator, has its output connected to the sub-harmonic mixer 1140 and a Power Amplifier (PA) 1190. The output of the PA 1190 is connected to the antenna 1110 through the matching network 1120.

It should be noted that the same radio architecture may be used for communications with other low-power radios without the master device with On-Off Key (OOK) signaling. On the receiver side, an orthogonal Phase Shift Keying (FSK) or Optical Phase Shift Keying (OFSK)/OOK modulation may be employed together with the direct-down conversion architecture. Orthogonal FSK is a special type of binary FSK (BFSK), where the modulation index of FSK is 1. OOK and binary FSK are two mostly used modulation schemes in Wireless Sensor Networks (WSN). OOK is very simple and basic, while FSK provides more design benefits besides simplicity. Therefore, in the transceiver system 1100 supports both modulation schemes are supported. Two important factoids about OFSK may be added.

Firstly, FSK tone frequency is selected with a balance between the requirements of bandwidth efficiency favoring closely spaced channels and low tone frequency, and the role of flicker noise in direct-conversion receiver architecture that favor large tone frequency. In one embodiment, with a data rate of 10 Mbit/s, a modulation index is chosen to be 1 results in two tones at 5M and 15M, which provides enough headroom to get rid off the problem of DC-offsets and flicker noise (corner frequency is about 200 KHz in QUBIC4X).

Secondly, the bandwidth of OFSK signal in is about two times of data rate 20 MHz, which is suitable for the 200 MHz bandwidth at 17 GHz free band. With proper channel spacing, about 8 channels are available, given the opportunity to adopt frequency spectrum spread in the future to improve energy efficiency.

The direct-conversion architecture is chosen for simplicity and high integration. Any DC-offsets and flicker noise problems may be solved by proper selection of FSK tone frequency above. 17 GHz RF signals are collected by a small on-chip patch antenna (about 4 mm by 4 mm) shown in FIG. 13, which may be shared with the transmitter. A simple matching circuit is provided for 50Ω impedance matching and performs the switching and isolation between receiver and transmitter at the same time. A duplexer is not needed here as the receiver and the transmitter are working in a TDMA fashion, which reduces the cost. Then a single-ended LNA amplifies the on band RF signals, which provides about 15 dB gain. A single-ended LNA may be used instead of a differential LNA due to the consideration that the more common single antenna is adopted here, together with a single-ended LNA eliminating the single to differential converter between antenna and LNA which will introduce insertion loss and is not good for system noise figure as a whole. In addition, a differential LNA typically has a 3 dB more noise figure compared with single-ended one and twice the power consumption, although the symmetrical circuit can provide less order distortion.

The output of the LNA is directly connected to the input of sub-harmonic mixer. The RF path is single-ended, and we generate 8 phases Local Oscillator (LO) signals with a phase step of 45 degree from 0 to 315 degrees. These 8 phases LO signals can be divided into two groups:

$$0 , \frac{π}{2} , π , \frac{3 π}{2} and \frac{π}{4} , \frac{3 π}{4} , \frac{5 π}{4} , \frac{7 π}{4} .$$

The same Radio Frequency (RF) signal is mixed with two groups of LO signals separately in two sub-harmonic mixers to generate I/Q differential Intermediate Frequency (IF) outputs. Considering that a high quality single to differential converter in the RF path is much more difficult to achieve and is power consuming, it is preferable that all the phase generation be in the LO path where 8 different phase LO signals around 8.6 GHz are needed. This may be achieved by first using a passive polyphase filter after differential resonator based on BAW device and then an interpolation network to generate 8 phases from the quadrature inputs. Sufficient amplitude and phase accuracy may be maintained by proper circuit design and layout.

Finally, in the IF part, a low pass filter (LPF) and automatic gain control (AGC) IF amplifier are included to perform channel selection and signal amplification to provide proper signal magnitude to be directly handled by the following frequency demodulator. In this architecture all the demodulation functions are performed in analog domain eliminating analog to digital converters (ADCs), which may add some extra power consumption. OOK demodulation is achieved by a square root detector, which calculates the square root of the amplitude of I/Q signals and compares it with a threshold voltage to decide base band signals to be 1 or 0. A frequency detector is used to complete OFSK demodulation. This method is insensitive to DC-offsets and I/Q mismatch.

The power consumption of a classical Phase Lock Loop (PLL) may be as high as 40% of the total power consumption and turn-on times are of the order of 100 μs. Therefore, based on current technologies, the above PLL-based methods are unachievable for low power budgets of a few Milli-Watts (mW), and short turn-on times of a few microseconds (μs). Alternatively, the design of a transceiver solution may not require a PLL. The local oscillator may be derived from a resonator such as bulk acoustic wave (BAW) device or a cavity-typed resonator. It is desirable to use a bulk acoustic wave (BAW) resonator as the frequency reference since this has the advantage of a very short turn-on time, such as a few μs. Very low phase noise figures may readily be achieved by BAW resonator. As to frequency accuracy, in a production process, the absolute frequency accuracy of BAW filters is expected to be as good as ±0.3%. In the 17 GHz band, this translates to a frequency error of ±49 MHz, which means that the radio will be able to make a “legal” transmission without further tuning or calibration (i.e. within the 200 MHz band). To further enhance the frequency accuracy, a master-slave network configuration may be helpful, which is described below.

This asymmetrical link with master-slave devices may be used for communication between the luminaire and a sensor attached to a plant associated with the luminaire. The sensor may communicate with the master device, in this case one of the luminaires in order to send information on humidity, temperature, light intensity etc. for processing by the master. The absolute frequency accuracy and robustness of this system may be further improved by using proper network configuration, such as a master-slave asymmetrical link system 1200, as shown in FIG. 12.

As shown in FIG. 12, the slave 1210 (ULP1) transmits first signals at a ULP frequency f_{RF1}. The master device 1220 is located in the same room and locks onto this transmission and then re-transmits on the ULP frequency f_{RF1} a signal with the required data. The ability of the master to continuously listen and search for the ULP transmission in both time and frequency space, is enabled by the fact that it is likely to be always powered and, consequently, has sufficient processing power to execute this search. Similar algorithms have been demonstrated in software-based GPS receivers. Using this approach, a viable link may be established. In addition, the sensitivity of the master device and the transmitted power from the master device are higher compared to that of the ULP nodes, and these attributes of increased sensitivity and increased power of the master device further act to allow reduction of power consumption in the ULP nodes.

In the same way, the master device will sense the presence of the other devices (ULPs) that send on different frequencies f_{RFn}. The absolute frequency accuracy problem is solved and the system becomes more robust. The master device allocates a time slot for the transmissions (depending on the required data rate) and a time slot is also allocated for the master to re-join the link, if necessary. In this way, the ULP devices contain minimum processing power, and are simply timers together with the receive and transmit (Rx/Tx) functions. The protocol may be TDMA-based and scheduling of the devices may avoid collisions and simultaneous operation of the ULPs. As in a ZigBee™ system, two ULPs may initiate a peer-to-peer virtual data transfer 1230 via the master device.

### Transmitter Architecture and Modulation Schemes

On the transmitter side, the transmitter (Tx) shares the same oscillator with the receiver and is turned-on/off by the data to provide an OOK modulation. The simplicity of this type of transmitter is without equal. As the transmitter is operating at a switching mode during data transmission, theoretically it will reduce transmitter power consumption compared to that consumed by an FSK transmitter (because the FSK transmitter must be on 100% of the time when data is being transmitted). In addition, since OOK signals only contain “0” and “1”, so the linearity of the Power Amplifier (PA) 1190 shown in FIG. 11 is not important here.

Non-linear PAs may be employed to increase PA efficiency. Moreover, the bias of the transmitter may be stable within a single bit period (0.1 μs) so that it may support data rated up to 10 MHz. The potential weak point of this OOK transmitter is that the peak current of PA may be higher than that of the FSK transmitter when they have the same average output power. This is not a problem here since by proper link budget calculation, the transmitter output power may be chosen to be relatively smaller to reduce PA peak current. In addition, energy scavenging techniques (such as using capacitor techniques to allow high peak currents, and proper choice of battery) may also be adopted to provide a transient high current surpass peak current limitation of typical battery in the very short transmitting period.

The different Tx/Rx modulation formats may be solved in the master-slave network configuration discussed before. The ULP node transmits OOK signals to master, where data are first demodulated and then modulated to OFSK signals. Then, the master sends the OFSK signals to ULP nodes, which may receive and demodulate it in the receiver path. Besides this OFSK modulation, the above transceiver architecture may also support direct communication between two ULP slave nodes using OOK modulation. In this way, a very simple low power transceiver architecture is achieved supporting both OOK and OFSK modulation schemes.

### Antenna System

In light with the requirements for wireless communications at millimeter-waves for luminaires, the antenna has small dimensions and sufficiently narrow beam. FIG. 13 shows one embodiment of an antenna 1300 which includes a differential dipole antenna. The differential dipole antenna comprises on a folded dipole 1310 and a circular metal plate 1320 in a lower metal from the stack. The role of the plate 1320 is to enlarge the antenna bandwidth and to present a better matching at the input of the same antenna.

Communication between modules will be delivered by the antenna system. This system comprises antenna arrays pointed horizontally and vertically. The horizontal arrays are used for wireless communication between modules and the vertical arrays are used for the communication with the sensors placed on the ground for sensing environmental conditions, such as temperature, humidity, light levels and the like. As shown in FIG. 15, each antenna array 1500 comprises several antennas in a configuration were the main beam is fairly focused on the desired target, such as the neighboring node or luminaire. The topology maybe changed to also meet other additional requirements as desired. FIG. 14 shows the efficiency 1400 of the antenna array which should be as high as possible to meet the communication path loss requirements. As shown in FIG. 14, the efficiency 1400 is more than 75% and combining this with the array's gain 1400 shown in FIG. 14, the power delivery is high.

The high frequency is necessary to fit the array system size in the luminaire's small area. The size of the antenna array is dependent on the frequency used to generate the radiating waves and that defines its size. At 17 GHz, the half wavelength of a single radiator in air is 8.82 mm and if the radiator is supported by a substrate with a dielectric constant of 4, then the radiator size will have half of its original size.

FIG. 16 shows various data 1600 of the antenna array and detection system, such as the power radiated being more then 5 Milli-Watts (mW) which is sufficient to overcome the desired distance between luminaire neighbors including the devices on the ground. This power level is sufficient to overcome the environment including the humidity and air contaminated with gases temperature. As shown in FIG. 16, the effective angle of the antenna beam is 78.56°, the beam directivity is approximately 9.2 dB and the antenna gain is approximately 8.5 dB, where the maximum intensity is approximately 0.004 Watts/Steradian.

The antenna array may also comprise other kind of radiators without compromising the topology of the array system and its functionality. The generic approach allows the adaptation of radiator elements as well as the array systems with what will be useful when other hostile or hazardous environments are encountered.

Of course, as it would be apparent to one skilled in the art of communication in view of the present description, various elements may be included in the system or network components for communication, such as transmitters, receivers, or transceivers, antennas, modulators, demodulators, converters, duplexers, filters, multiplexers etc. The communication or links among the various system components may be by any means, such as wired or wireless for example. The system elements may be separate or integrated together, such as with the processor. As is well-known, the processor executes instructions stored in the memory, for example, which may also store other data, such as predetermined or programmable settings related to system control.

Various modifications may also be provided as recognized by those skilled in the art in view of the description herein. The operation acts of the present methods are particularly suited to be carried out by a computer software program. The application data and other data are received by the controller or processor for configuring it to perform operation acts in accordance with the present systems and methods. Such software, application data as well as other data may of course be embodied in a computer-readable medium, such as an integrated chip, a peripheral device or memory, such as the memory or other memory coupled to the processor of the controller.

The computer-readable medium and/or memory may be any recordable medium (e.g., RAM, ROM, removable memory, CD-ROM, hard drives, DVD, floppy disks or memory cards) or may be a transmission medium (e.g., a network comprising fiber-optics, the world-wide web, cables, and/or a wireless channel using, for example, time-division multiple access, code-division multiple access, or other wireless communication systems). Any medium known or developed that can store information suitable for use with a computer system may be used as the computer-readable medium and/or memory.

Additional memories may also be used. The computer-readable medium, the memory, and/or any other memories may be long-term, short-term, or a combination of long- and -short term memories. These memories configure the processor/controller to implement the methods, operational acts, and functions disclosed herein. The memories may be distributed or local and the processor, where additional processors may be provided, may be distributed or singular. The memories may be implemented as electrical, magnetic or optical memory, or any combination of these or other types of storage devices. Moreover, the term “memory” should be construed broadly enough to encompass any information able to be read from or written to an address in the addressable space accessed by a processor. With this definition, information on a network, such as the Internet, is still within memory, for instance, because the processor may retrieve the information from the network.

The controllers/processors and the memories may be any type. The processor may be capable of performing the various described operations and executing instructions stored in the memory. The processor may be an application-specific or general-use integrated circuit(s). Further, the processor may be a dedicated processor for performing in accordance with the present system or may be a general-purpose processor wherein only one of many functions operates for performing in accordance with the present system. The processor may operate utilizing a program portion, multiple program segments, or may be a hardware device utilizing a dedicated or multi-purpose integrated circuit. Each of the above systems utilized for identifying the presence and identity of the user may be utilized in conjunction with further systems.

Finally, the above-discussion is intended to be merely illustrative of the present system and should not be construed as limiting the appended claims to any particular embodiment or group of embodiments. Thus, while the present system has been described in particular detail with reference to specific exemplary embodiments thereof, it should also be appreciated that numerous modifications and alternative embodiments may be devised by those having ordinary skill in the art without departing from the broader and intended spirit and scope of the present system as set forth in the claims that follow. The specification and drawings are accordingly to be regarded in an illustrative manner and are not intended to limit the scope of the appended claims.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same or different item or hardware or software implemented structure or function;

e) any of the disclosed elements may be comprised of hardware portions (e.g., including discrete and integrated electronic circuitry), software portions (e.g., computer programming), and any combination thereof;

f) hardware portions may be comprised of one or both of analog and digital portions;

g) any of the disclosed devices or portions thereof may be combined together or separated into further portions unless specifically stated otherwise; and

h) no specific sequence of acts or steps is intended to be required unless specifically indicated.

1. A node detection system comprising:
an array of nodes wherein each node of the array of nodes has at least two directional antennas (530) configured to have antenna beams in a number of directions, a range of the antenna beams being limited to reach a neighboring operational node of the array of nodes for transmission of a message to the neighboring operational node; and
a controller configured to receive messages from the array of nodes and determine a location of the each node based on the messages.

2. The node detection system of claim 1, wherein the each node is configured to determine the location of the each node based on the messages.

3. The node detection system of claim 1, wherein transmission frequency of the message is substantially 17 GHz or 24 GHz.

4. The node detection system of claim 1, wherein the message includes at least one of a message identifier of an originating node that originally transmitted the message, a forward counter indicator and a backward counter indicator.

5. The node detection system of claim 4 wherein, when a receiving node receives the message on a first antenna and the message identifier is not equal to a receiving identifier of the receiving node, then the forward counter indicator is incremented and a first modified message is transmitted from a second antenna which is opposite the first antenna and the backward counter indicator is incremented and a second message is transmitted back from the first antenna.

6. The node detection system of claim 5 wherein, when the originating node receives the second message having the message identifier equal to a node identifier of the originating node, and the forward counter indicator is equal to the backward counter indicator, then the forward counter indicator and the backward counter indicator are stored in the originating node as a position indicator of one of a row number and a column number of the originating node in the array.

7. The node detection system of claim 6 wherein, when a stored message is already stored in the originating node, then the originating node keeps a message having a largest value for the forward counter indicator and the backward counter indicator.

8. The node detection system of claim 5, wherein a location message containing the message identifier of the originating node, the row number, the column number and a row counter indicator of the originating node is transmitted down to a last row of the array through at least one intermediate node, the row counter indicator being incremented each time the location message is transmitted down a row, and largest values are kept for the row number and the column number included in the location message and associated with the at least one intermediate node, wherein the controller collects the location message from last row.

9. The node detection system of claim 1, wherein nodes in one row of the array are configured to determine their respective locations relative to each other by a first node transmitting a message forward and backward, the message including a node identity of the first node, a forward counter value and a backward counter value, a second node receiving the message incrementing the forward counter and transmitting the message forward, and incrementing the backward counter and transmitting the message backward, wherein the first node saves left and right values indicative of a location of the first node in the one row when received messages received from a left side and a right side, respectively, by the first node include the node identity and the backward counter value equals the forward counter value.

10. The node detection system of claim 9, wherein the first node keeps highest values of the left and right values.

11. The node detection system of claim 9, wherein a stored message stored in the first node is transmitted down to a last row and a row_counter incremented for collection by the controller.

12. The node detection system of claim 11, wherein the left and right values in the stored message are substituted with larger left and right values of nodes in lower rows.

13. A method of determining locations of nodes in an array comprising the act of:
providing an array of nodes, wherein each node of the array of nodes has at least at least two, three or four directional antennas configured to have antenna beams in a number of directions, a range of the antenna beams being limited to reach a neighboring operational node of the array of nodes for transmission of a message to the neighboring operational node;
sending messages from the array of nodes to a controller; and
determining a location of the each node based on the messages.

14. The method of claim 13, wherein the as many directions are orthogonal to each other and are in one or more planes, and wherein the sending act is performed at substantially 17 GHz or 24 GHz.

15. The method of claim 13, further comprising the acts of:
receiving the message by a first antenna of a receiving node sent by an originating node;
when a message identifier of the message is not equal to a receiving identifier of the receiving node, incrementing a forward counter indicator of the message to form a first modified message and transmitting the first modified message by a second antenna of a receiving node, the second antenna being opposite to the first antenna, and incrementing a backward counter indicator of the message to form a second modified message and transmitting the second modified message by the first antenna of; and
when the originating node receives the second modified message having the message identifier equal to a node identifier of the originating node, and the forward counter indicator is equal to the backward counter indicator, then the forward counter indicator and the backward counter indicator are stored in the originating node as a position indicator of one of a row number and a column number of the originating node in the array.

16. The method of claim 13, further comprising the act of outputting a mapping of locations of the nodes in the array.

17. A computer readable medium embodying a computer program, the computer program when executed by a processor is configured to determine locations of wireless nodes in an array by performing the act of:
transmitting by a first node a message forward and backward, the message including a node identity of the first node, a forward counter value and a backward counter value;
a second node that receives the message incrementing the forward counter and transmitting the message forward, and incrementing the backward counter and transmitting the message backward; and
saving by the first node left and right values indicative of a location of the first node in the one row when received messages received from a left side and a right side, respectively, by the first node include the node identity and the backward counter value equals the forward counter.

18. A node detection system comprising an array of nodes, wherein each node of the array of nodes has at least two, three or four directional antennas configured to have antenna beams in as many directions, a range of the antenna beams being limited to reach a neighboring operational node of the array of nodes for transmission of a message to the neighboring operational node; and wherein the each node is configured to determine a location of the each node based on the messages and to store the location in a memory of the node.
